(19) United States
(12) Patent Application Publication
(10) Pub. No.: US 2008/0056180 A1
(43) Pub. Date: Mar. 6, 2008

(54) Method of determining a serving sector switch with minimum forward link MAC channel feedback in a wireless communication system

(76) Inventors: Gang Li, Bridgewater, NJ (US); Ming Lu, Hillsborough, NJ (US); Jialin Zou, Randolph, NJ (US)

Correspondence Address: Lucent Technologies Inc., Docket Administrator - Room 3J-219, 101 Crawfords Corner Road, Holmdel, NJ, 07733-3030, US

(21) Appl. No.: 11/514,439

(22) Filed: Sep. 1, 2006

(51) Int. Cl. H04Q 7/00

(52) U.S. Cl. 370/329

(57) ABSTRACT

In an H-ARQ system, when transmission on the FL MAC channel of DRCLock or CQILock bits is eliminated, other feedback information carried by the FL MAC channel is used as an RL quality indication for determining at least in part when to make a serving sector switch from a current serving sector to a non-serving sector in its active set. In particular, when data traffic is present, the ACKs/NAKs fed back to the AT on the FL MAC channel are used at least in part in determining when to make such a serving sector switch. In systems operating in accordance with CDMA2000 EVDO RevA/RevB standards, for example, this information is used in conjunction with quality measurements on the FL in determining when to make a serving sector switch. In future systems operating in accordance with CDMA2000 EVDO RevC standards currently under development in which the RL can be switched independently of the FL, this information is directly used to determine when to make an RL serving sector switch.

### TECHNICAL FIELD

This invention relates to wireless communications.

### BACKGROUND OF THE INVENTION

In accordance with adopted CDMA2000 EVDO RevA/RevB standards and the RevC standard currently under development, the forward link (FL) MAC (Medium Access Control) channel carries an ACK/NAK (ACKnowledgment/Negative AcKnowledgment) sub-channel, a Reverse Link (RL) Power Control Bit (PCB) sub-channel, and a Data Rate Control (DRC) Lock (DRCLock) sub-channel. The Access Network (AN) communicates with a plurality of Access Terminals (ATs) using different Walsh codes. In communicating with each AT, the ACK/NAK bits transmitted on the FL by the AN are used to support the H-ARQ (Hybrid Automatic Repeat Request) of RL traffic transmissions; the RL PCBs are used for RL power control; and the DRCLock bits are used to indicate the quality of the RL DRC channel (i.e, good quality [in-lock], or bad quality [out-of-lock]). The DRC channel on the RL itself carries a request for the AN to send data traffic to the AT on the FL at a certain data rate. New systems that will be in accord with CDMA2000 EVDO RevC standards currently under development will support both an SBC mode and an LBC mode. In the SBC mode, the RL DRC sub-channel on the FL is used to request a certain traffic data rate on the FL and the DRCLock sub-channel on the FL MAC channel is used to indicate the quality of the DRC sub-channel. In a possible alternative option, a CQI (Channel Quality Indicator) sub-channel replaces the DRC sub-channel on the RL and a CQILock sub-channel replaces the DRCLock sub-channel on the FL MAC channel. The CQI sub-channel indicates to the AT a measure of the pilot received on the FL, and is a measure of the FL quality. The CQILock sub-channel is used to indicate the quality of the CQI sub-channel. In this case, rather than having the AT decide upon an FL data rate, the AN selects an FL data rate based on the received CQI.

Simulations and tests have shown that when the FL MAC channel is overloaded with simultaneous transmissions to multiple users, a high error rate of ACK/NAKs and PCBs results, thereby causing a delay increase and overall throughput reduction on the RL. Thus, while new technologies such as Interference Cancellation (IC) that can now be employed on the RL have the potential for significantly increasing the RL capacity, the limitations of the FL MAC capacity create a bottleneck, thereby acting as a limiting factor on any such ability to increase the RL traffic capacity.

Co-pending U.S. patent application Ser. No. 11/331,994, filed Jan. 13, 2006, and entitled “Method of Reverse Link Dynamic Power Control in a Wireless Communication System Using Quality Feedback from a Delay-Sensitive Traffic Stream or Overhead Channel,” discloses using ACK/NAK bits when data traffic is present on the RL and DRC data quality indication bits when traffic is not present on the RL, for purposes of conducting closed-loop power control. The DRC data quality indication bits indicate the quality of the DRC data received on the RL DRC channel from an AT. As a result, the number of PCBs transmitted over the FL MAC channel can be reduced and the loading of the FL MAC channel relieved. The transmission of the DRCLock bits, however, continues to appear through simulations to be a big contributor of FL MAC channel loading and thus a limiting factor on RL traffic capacity.

The present applicants describe in their co-pending U.S. patent application Ser. No. ______, filed Aug. 24, 2006, entitled “Method of Increasing the Capacity of the Forward Link MAC Channel in a Wireless Communication System”, a method for increasing RL traffic capacity through the elimination altogether of the DRCLock bits. Currently, in RevA/RevB systems, an AT uses those DRCLock bits as part of its switch mechanism for determining when to switch from its current serving sector to another non-serving sector within its active set. Specifically, the existing switch mechanism requires the AT to know not only the quality of the FL based on FL pilot measurements, but also the RL quality based on the DRCLock bits received on the FL MAC channel. Since in these systems the FL and RL are aligned with the same serving sector, quality measures of both the FL and the RL are required in deciding if and when to make a serving sector switch. In accordance with the RevC standards currently under development, the FL serving sector and the RL serving sector can be separately switched from its current serving sector to a “better” non-serving sector. An FL serving sector switch and an RL serving sector switch can thus be conducted independently with the RL serving sector switch being based on an RL quality indication. If the DRCLock bits are totally eliminated in a system in accord with RevA/RevB standards or in a future system in accord with the SBC mode the RevC standards under development, or if the CQILock bits are eliminated in a system in accord with the other option of the RevC standards under development, a different methodology is required to support either an independent RL serving sector switch that is determined based on measured RL quality, or an aligned FL and RL serving sector switch that is determined based on both FL and RL quality measurements.

### SUMMARY OF THE INVENTION

In accordance with an embodiment of the present invention, with transmission on the FL MAC channel of DRCLock bits eliminated, other feedback information carried by the FL MAC channel is used by the AT as input for determining at least in part when to make a serving sector switch from a current serving sector to a non-serving sector in its active set. In particular, when data traffic is present, the ACKs/NAKs fed back to the AT on the FL MAC channel are used at least in part in determining when to make such a serving sector switch. In RevA/RevB systems, for example, this information is used in conjunction with quality measurements on the FL in determining when to make a serving sector switch. In RevC systems, where the RL can be switched independently of the FL, this information is directly used to determine when to make an RL serving sector switch.

In an embodiment, when data traffic is present on the RL, the statistics of ACKs and NAKs being received on the FL MAC channel from the serving sector in the AN and the other non-serving sectors in an AT's active set in the AN are used at least in part in determining when to make a serving sector switch. Specifically, in an embodiment, quality measures of the RL from the serving sector and from non-serving sector are determined from a measurement over a predetermined interval of time of the statistics of the ACKs and/or NAKs received on a FL MAC channel from a serving sector and the statistics of ACKs and/or NAKs received on a FL MAC channel from a non-serving sector. (The statistics are, in fact, the short-term packet error rate). When the difference between quality measures is greater than a predetermined threshold, the AT determines that the RL to the non-serving sector has a “better” quality than the RL to the serving sector. In a RevA/RevB system in which the FL and RL serving sectors are aligned, that information, and further, the degree to which the quality measure of the serving sector RL is below the quality measure of a non-serving sector RL as determined from the statistics of the ACKs and NAKs received on both RLs, are used together with quality measures of the FLs from both the serving and non-serving sectors to determine when a switch from the current serving sector to the non-serving sector with a better link quality. In a RevC system in which an RL serving sector switch can be made independently of an FL serving sector switch, that determination is made directly from the statistics of the ACKs and NAKs received on both RLs. Depending on the predetermined period of time over which the ACKs and NAKs received from the serving and non-serving sectors are measured, the AT can select and point to the data source (i.e., sector in its active set) having the lowest short-term packet error rate.

When data traffic is not present on the RL, however, information that is fed back on the FL MAC channel that is indicative of the quality of the RL is used at least in part to determine when an AT should make a serving sector switch from a current serving sector to a non-serving sector in the its active set. That information can be, for example, a DRC data quality indication (or CQI data quality indication) that optionally may be transmitted on the FL over the MAC channel, or the afore-noted RL pilot quality indication, derived by the AN from the RL pilot and fed back on the FL MAC channel to the AT. The statistics of “good” and “bad” RL channel quality indications are then used at least in part to determine when to make a serving sector switch.

### BRIEF DESCRIPTION OF THE DRAWING

The present invention will be better understood from reading the following description of non-limiting embodiments, with reference to the attached drawings, wherein below:

FIG. 1 is a block diagram of a prior art wireless communication system showing an AT in communication with an AN via both a serving sector at a first BTS (Base Transceiver Station) and a non-serving sector within its active set at a second BTS;

FIG. 2 is a block diagram of a prior art wireless communication system showing in further detail the communication channels between an AT and a BTS within an AN in accordance with CDMA2000 EVDO RevA/RevB standards and RevC standards currently under development; and

FIG. 3 is a flowchart showing a method at an AT for determining when an AT RL sector switch should be made in accordance with an embodiment of the present invention.

### DETAILED DESCRIPTION

Although the following description is in accordance with adopted CDMA2000 EVDO RevA/RevB standards and RevC standards currently under development, and uses terminology commonly associated with those standards, it should be understood that the present invention could be used in other embodiments. The term Access Terminal, AT, should thus be understood to encompass any type of wireless terminal, cell phone, user equipment, etc. and the term Access Network, AN, should be understood to encompass any type of wireless communication network that includes a base station, base transceiver station, mobile switch, or other equivalent terminal with which a wireless terminal directly communicates. An ACK and a NAK represents any type of positive and negative acknowledgments that received data has been respectively successfully or unsuccessfully decoded.

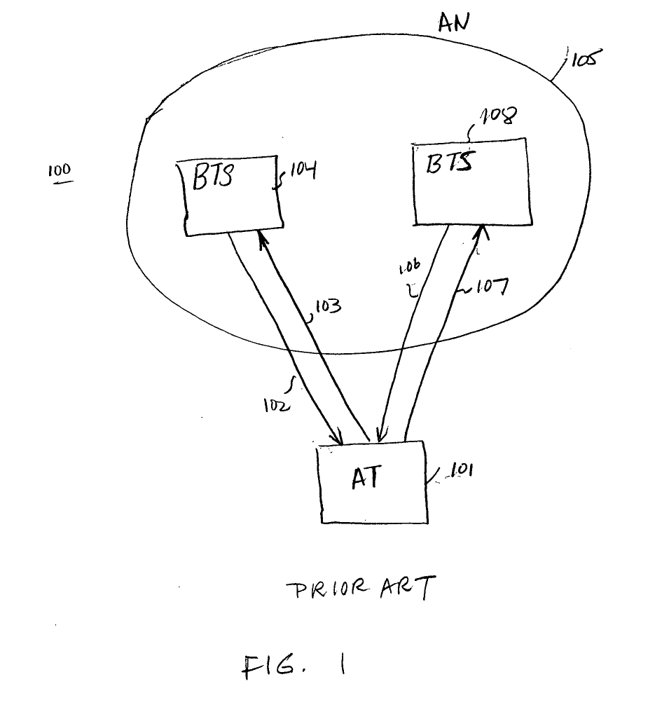

With reference to FIG. 1, in a prior art wireless communication system 100 in accordance with CDMA2000 EVDO RevA/RevB standards, and RevC standards under development, AT 101 communicates over FL 102 and RL 103 with a serving sector in BTS 104 within AN 105. AT 101 also communicates over FL 106 and RL 107 with a non-serving sector in BTS 108. In RevA/RevB systems, when the measured quality of the FL 102 and/or RL 103 degrade and the measured quality on the FL 106 and/or RL 107, respectively, are determined to be “better,” then a serving sector switch is made to the sector in BTS 108. In RevA/RevB systems, the FL and RL are aligned so that a serving sector switch effects a switch of both the FL 102 and RL 103 to FL 106 and 107, respectively. In general, a serving sector switch is made based on a combination of a comparison between the measured qualities of FL 102 and FL 106, and a comparison of the measured qualities of RL 103 and RL 107. In accordance with the RevC standards under development, the FL and RL do not necessarily have to be in the same sector so that separate FL and RL serving sector switches can be made. In particular, an RL serving sector switch can be made from a sector of BTS 104 to a sector of BTS 108 based upon a comparison of the measured qualities of RLs 103 and 107.

In accordance with RevA/RevB standards, and the RevC standards under development, DRCLock bits (or CQILock bits in other option), are used as a RL quality measure. If the DRCLock bits (and/or CQILock bits) are eliminated, the embodiments of the present invention use alternate methods for determining RL quality.

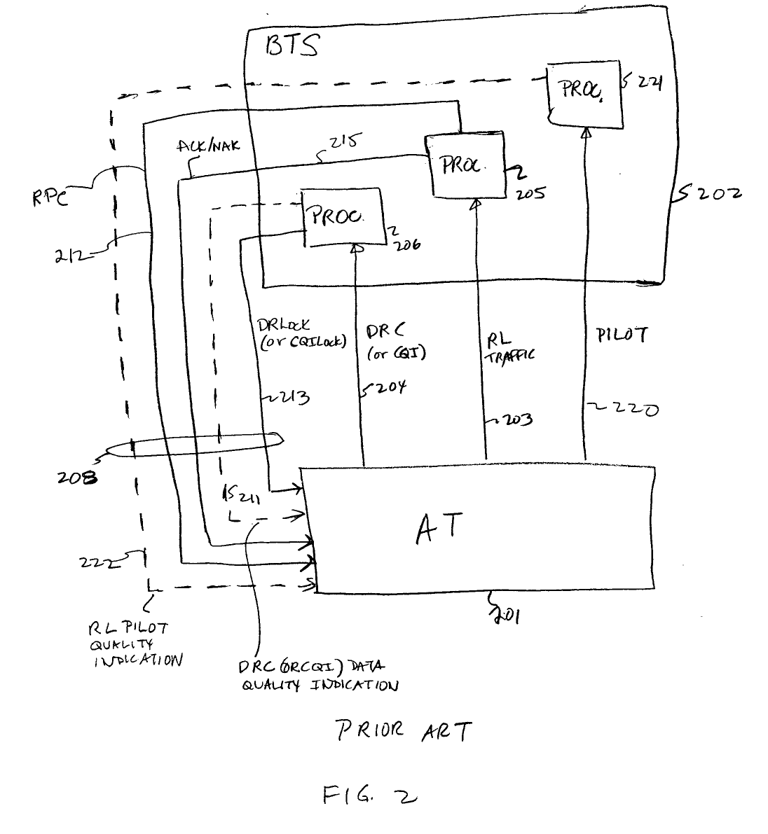

With reference to FIG. 2, in a prior art wireless communication system 200 in accordance with CDMA2000 EVDO RevA/RevB standards and RevC standards under development, AT 201 transmits data to BTS 202 within AN 210 over the RL traffic channel 203. Depending on its length, data is transmitted in multiple sub-packets, each sub-packet consisting of four slots, each slot having a duration of 1.667 ms. AT 201 also transmits on DRC sub-channel 204 a rate request for the AN to transmit data to it. Alternatively, AT 201 transmits a CQI on sub-channel 204. A processor 205 in BTS 202 processes the data sub-packets received over RL traffic channel 203 and generates either an ACK or a NAK on sub-channel 215, indicating, respectively, a successful or unsuccessful decoding of each transmitted sub-packet. Processor 205 also generates, according to the afore-noted EVDO RevA/RevB standards, RL Power Control (RPC) bits (PCBs), which are transmitted on sub-channel 212 over the FL MAC channel 208 to the AT requesting it to increase or decrease its transmit power. A processor 206 in BTS 202, which may be separate from or integrated with processor 205, processes the data rate request transmitted by AT 201 on DRC channel sub-204 and sets the FL (not shown) data rate. For the other option, processor 206 processes the CQI transmitted by AT 201 on sub-channel 204 and determines a data rate for transmission on the FL using that CQI. AT 201 also transmits a pilot signal on the RL on sub-channel 220 to a processor 221. Optionally, processor 221 generates an RL Pilot Quality indication on sub-channel 222, which is transmitted on the FL MAC channel 208. To indicate its optional nature, a dotted connection is shown between processor 221 and AT 201. The functions of processors 205, 206 and 221 in an actual embodiment are likely to be integrated with the general processing functionalities of a common BTS processor that performs control functions and traffic processing at the BTS. Processor 206 determines whether the quality of DRC (or CQI) sub-channel 204 is “good” or “bad”, and outputs DRCLock bits (or CQILock bits), on sub-channel 213, in which a “1” indicates a “good”, in-lock, DRC (or a “good” CQI) sub-channel, and which a “0” indicates a “bad”, out-of-lock, DRC (or a “bad” CQI) sub-channel. The MAC channel 208 transmitted by BTS 202 includes the ACK/NAK sub-channel 215, the reverse link power control sub-channel 212, the DRCLock (or CQILock) sub-channel 213, potentially the afore-noted RL Pilot Quality indication sub-channel 222, and also potentially a DRC (or CQI) data quality indication sub-channel 211, which, in accordance with the afore-noted co-pending patent application relating to reverse link dynamic power control, is indicative of the quality of the DRC (or CQI) data received on DRC (or CQI) sub-channel 204. The latter sub-channel 211 is also shown as a dotted connection between processor 206 in BTS 202 and AT 201 to indicate that this sub-channel is optional. For a given user, the ACK/NAK sub-channel 214 and the DRCLock sub-channel 213 are time-division multiplexed and transmitted in one out of every four slots.

The afore-noted present inventor's co-pending patent application relating to a method of increasing the capacity of the forward link MAC channel, describes a method in which capacity is increased by totally eliminating the transmission of the DRCLock bits. For the other optional embodiment, transmission of CQILock bits would be similarly eliminated. As previously noted, the DRCLock (or CQILock) bits provide an RL quality indication, which is used for determining when a serving sector switch should be made.

As previously noted, therefore, the present invention provides a methodology for determining when a serving sector switch is needed when no DRCLock or CQILock are transmitted on the FL MAC channel. Specifically, when data traffic is present on the RL, the statistics of the responsive ACKs/NAKs transmitted to the AT over the FL MAC channel are used as a RL quality measure used at least in part for determining when the AT should make a serving sector switch. When data traffic is not present on the RL, other information that is fed back on the FL MAC channel and that is indicative of the quality of the RL is used at least in part to determine when the AT should make a serving sector switch. That information can be, for example, a DRC data quality indication (or CQI data quality indication) that optionally may be transmitted on the FL over the MAC channel, or the afore-noted RL pilot quality indication, derived by the AN from the RL pilot and fed back on the FL MAC channel to the AT. The statistics of “good” and “bad” RL channel quality indications are then used at least in part to determine when to make a serving sector switch.

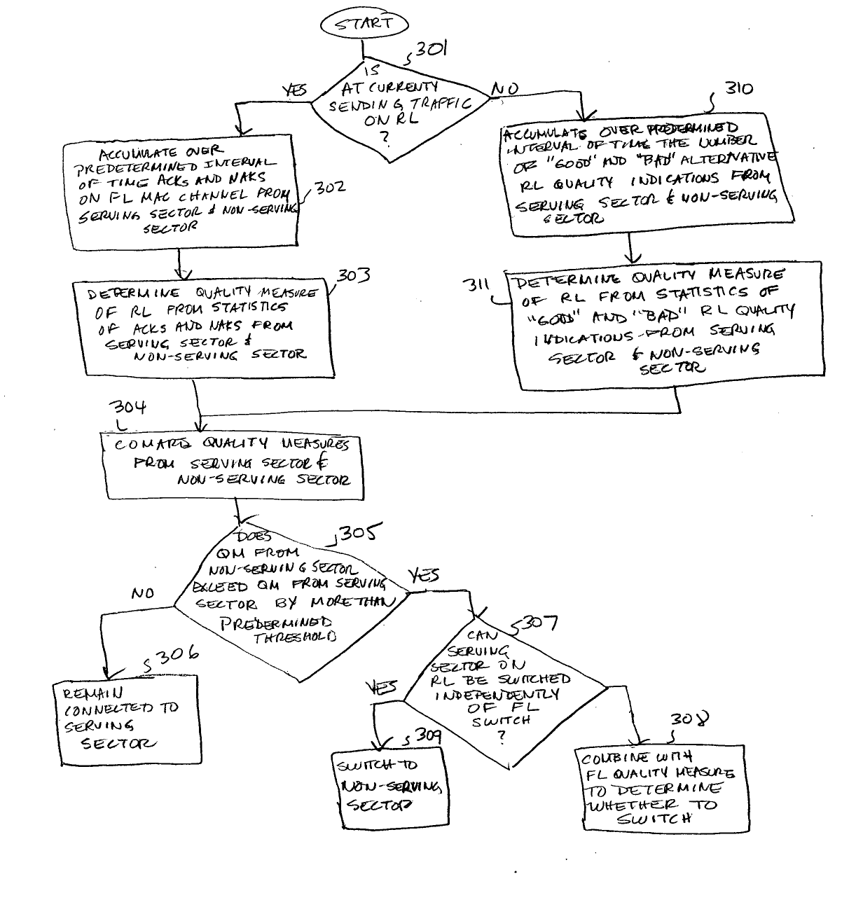

FIG. 3 is a flowchart showing the steps of an embodiment of the present invention as performed by an AT. At step 301 a determination is made whether the AT is currently transmitting traffic on the RL. If yes, at step 302, over a predetermined period of time, the number of responsive ACKs and NAKs received by the AT over the FL MAC channel from the serving sector and from the one or more non-serving sectors are accumulated. At step 303, a quality measure is determined for the RL to the serving sector and to the one or more non-serving sectors from the statistics of the ACKs/NAKs, received from each sector, in particular the percentages of ACKs and NAKs. At step 304, a comparison of quality measures is made. At step 305, a determination is made whether the difference between the quality measure of the RL to one of the non-serving sectors and the quality measure of the RL to the serving sector is greater than a predetermined threshold. If not, at step 306, the AT remains connected to its serving sector. If yes, at step 307, a determination is made whether the serving sector for the RL can be switched independently of the FL. If it cannot be independently switched (e.g., RevA/RevB systems), then, at step 308, the determined RL quality measure is combined with determined FL quality measures to determine whether a sector switch should be made. If it can be independently switched (e.g., RevC system), then at step 309, a RL switch to a non-serving sector having the best RL quality measure is made.

If the AT is not currently sending traffic on the RL to the AN, then an alternative measure of RL quality is used. As noted above, this alternative measure that is indicative of the quality of the RL can be information that is fed back on the FL MAC channel such as, for example, a DRC data quality indication (or CQI data quality indication) that optionally may be transmitted on the FL over the MAC channel, or the afore-noted RL pilot quality indication, derived by the AN from the RL pilot and fed back on the FL MAC channel to the AT. The statistics of “good” and “bad” RL channel quality indications are then used at least in part to determine when to make a serving sector switch. Thus, if at step 301, the AT is not currently sending traffic on the RL to the AN, then at step 310 the over a predetermined period of time, the number of “good” and “bad” RL alternative channel quality indications by the AT over the FL MAC channel from the serving sector and from the one or more non-serving sectors are accumulated. At step 311, a quality measure is determined for the RL to the serving sector and to the one or more non-serving sectors from the statistics of the “good”/“bad” quality indications, received from each sector, in particular the percentages of “goods” and “bads”. After step 311, the flow goes to step 304 at which, as described above, a comparison of quality measures is made. As before, at step 305 a determination is made whether the difference between the quality measure of the RL to one of the non-serving sectors and the quality measure of the RL to the serving sector is greater than a predetermined threshold. If not, at step 306, the AT remains connected to its serving sector. If yes, at step 307, a determination is made whether the serving sector for the RL can be switched independently of the FL. If it cannot be independently switched (e.g., RevA/RevB systems), then, at step 308, the determined RL quality measure is combined with determined FL quality measures to determine whether a sector switch should be made. If it can be independently switched (e.g., a RevC system), then at step 309, a RL switch to a non-serving sector having the best RL quality measure is made.

Advantageously, by selecting the time interval over which quality measurements and decision are made, the AT is able to quickly perform a serving sector switch to minimize a short-term packet error rate.

The above-described embodiments are illustrative of the principles of the present invention. Those skilled in the art could devise other embodiments without departing from the spirit and scope of the present invention.

The invention claimed is:

1. A method in a H-ARQ wireless communication system in which an access terminal (AT) communicates with a access network (AN) over a forward link (FL) and reverse link (RL) to a and a, the method comprising:
at the AT:
determining statistics of ACKs and NAKs received on the FL that are generated by the AN in response to successful and unsuccessful decodings, respectively, of data traffic packets being transmitted by the AT on the RL; and
deciding when to switch from its current serving sector to another sector in its active set using at least in part the determined statistics of ACKs and NAKS.

2. The method of claim 1 further comprising:
when data traffic packets are not being transmitted by the AT on the RL:
determining statistics of other information received on the FL that is indicative of a “good” or “bad” quality of the RL;
deciding when to switch from its current serving sector to another sector in its active set using at least in part the determined statistics of the other information.

3. The method of claim 2 wherein the other information comprises a Date Rate Channel (DRC) data quality indication.

4. The method of claim 2 wherein the other information comprises a RL pilot quality indication.

5. The method of claim 2 wherein the other information comprises a CQI data quality indication.

6. The method of claim 1 wherein the AT uses the determined statistics of ACKs and NAKs in conjunction with determined FL quality measures in deciding when to switch from its current serving sector to another sector in its active set.

7. The method of claim 1 wherein the AT directly uses the determined statistics of ACKs and NAKs in deciding when to switch its RL from its current serving sector to another sector in its active set.

8. The method of claim 2 wherein the AT uses the statistics of the “good” and “bad” RL quality indications in conjunction with determined FL quality measures in deciding when to switch from its current serving sector to another sector in its active set.

9. The method of claim 2 wherein the AT directly uses the statistic of the “good” and “bad” quality indications in deciding when to switch its RL from its current serving sector to another sector in its active set.

10. The method of claim 1 wherein the statistics of ACKs and NAKs are measured over a predetermined interval of time and the decision to switch from the current serving sector to another sector is made at least in part if the percentage of ACKs (or alternatively NAKs) that are received from the other sector in that interval is greater by (less than in the alternative) a predetermined threshold than the percentage of ACKs (NAKs in the alternative) that are received from the current sector.

11. The method of claim 2 wherein the statistics of “good” and “bad” RL quality indications are measured over a predetermined interval of time and the decision to switch from the current serving sector to another sector is made at least in part if the percentage of “good” indications (or alternatively “bad” indications) that are received from the other sector in that interval is greater by (less than in the alternative) a predetermined threshold than the percentage of “good” indications (“bad” indications in the alternative) that are received from the current sector.
